(19) United States
(12) Patent Application Publication
(10) Pub. No.: US 2026/0039409 A1
(43) Pub. Date: Feb. 5, 2026

(54) STRUCTURE AND METHOD FOR OPTICAL MULTICHANNEL RECEIVER

(71) Applicant: TAIWAN SEMICONDUCTOR MANUFACTURING COMPANY LTD., HSINCHU (TW)

(72) Inventors: TAI-CHUN HUANG, NEW TAIPEI CITY (TW); STEFAN RUSU, SUNNYVALE, CA (US)

(21) Appl. No.: 18/961,516

(22) Filed: Nov. 27, 2024

Related U.S. Application Data
(60) Provisional application No. 63/678,565, filed on Aug. 2, 2024.

(51) Int. Cl. H04J 14/02; H04J 14/08

(52) U.S. Cl. CPC H04J 14/0204; H04J 14/08

(57) ABSTRACT

A method includes: receiving a combined optical signal including a first plurality of optical signals and a second plurality of optical signals; during a first time period, individually generating the first plurality of optical signals by a wavelength division demultiplexer; during a second time period, individually generating the second plurality of optical signals by the wavelength division demultiplexer; and subsequent to the second time period, converting the first plurality of optical signals and the second plurality of optical signals into a plurality of electrical signals respectively.

### PRIORITY CLAIM AND CROSS-REFERENCE

This application claims the benefit of U.S. provisional application No. 63/678,565 filed Aug. 2, 2024, the disclosure of which is incorporated by reference herein in its entirety.

### BACKGROUND

Artificial intelligence (AI) is an emerging technique in recent years and has been becoming a powerful tool to simulate human intelligence by machines that are programmed to think and act like humans. AI has attracted lots of attention since its applicable scenarios are more prevalent than any other previous high technologies, and can be used in a variety of applications and industries. Due to the attribute of an enormous computational load of the AI applications, efforts have been made to realize the AI techniques with reduced power consumption and higher computation efficiency. Optical circuits have drawn a lot of attention for the advantages of lower energy consumption and greater processing speed as compared to their electrical counterpart.

### BRIEF DESCRIPTION OF THE DRAWINGS

Aspects of the present disclosure are best understood from the following detailed description when read with the accompanying figures. It should be noted that, in accordance with the standard practice in the industry, various structures are not drawn to scale. In fact, the dimensions of the various structures may be arbitrarily increased or reduced for clarity of discussion.

FIG. 1 illustrates a block diagram of a neural network, in accordance with some embodiments.

FIG. 2 illustrates a block diagram of a semiconductor device for implementing the neural network shown in FIG. 1, in accordance with some embodiments of the present disclosure.

FIG. 3A illustrates a block diagram of a multichannel receiver of the semiconductor device shown in FIG. 2, in accordance with some embodiments of the present disclosure.

FIG. 3B shows signal waveforms and spectral responses of a data-only combined optical signal, in accordance with some embodiments of the present disclosure.

FIG. 4A shows a block diagram of a single-stage Mach-Zehnder interferometer (MZI), in accordance with some embodiments of the present disclosure.

FIG. 4B shows a chart illustrating power distributions in two arms of an MZI, in accordance with some embodiments of the present disclosure.

FIG. 4C shows a block diagram of a two-stage MZI 401, in accordance with some embodiments of the present disclosure.

FIG. 4D shows a block diagram of time-division and wavelength-division de-multiplexing of optical signals, in accordance with some embodiments of the present disclosure.

FIG. 5 shows a block diagram of a generalized MZI, in accordance with some embodiments of the present disclosure.

FIGS. 6A, 6B, 6C, 6D, 6E and 6F show block diagrams of cross-sectional views of an MZI, in accordance with some embodiments of the present disclosure.

FIG. 7 shows a block diagram of a cross-sectional view of an MZI, in accordance with some embodiments of the present disclosure.

FIG. 8 illustrates a block diagram of a comparator of the semiconductor device shown in FIG. 2, in accordance with some embodiments of the present disclosure.

FIG. 9 illustrates a block diagram of a multichannel receiver, in accordance with some embodiments of the present disclosure.

FIG. 10A illustrates a block diagram of a multichannel receiver, in accordance with some embodiments of the present disclosure.

FIG. 10B shows a signal waveforms and spectral responses of a data-only combined optical signal, in accordance with some embodiments of the present disclosure.

FIG. 11 illustrates a block diagram of a cross-sectional view of the semiconductor device shown in FIG. 2, in accordance with some embodiments of the present disclosure.

FIG. 12 shows a schematic flow chart of a method of operating a multichannel receiver, in accordance with some embodiments of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings. Further, like reference numerals across different figures dictate similar features, and therefore a detailed explanation of the similar feature may be provided when such features are first introduced in the disclosure, and may not be subsequently repeated.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper,” “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the deviation normally found in the respective testing measurements. Also, as used herein, the terms “about,” “substantial” or “substantially” generally mean within 10%, 5%, 1% or 0.5% of a given value or range. Alternatively, the terms “about,” “substantial” or “substantially” mean within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the terms “about,” “substantial” or “substantially.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as being from one endpoint to another endpoint or between two endpoints. All ranges disclosed herein are inclusive of the endpoints, unless specified otherwise.

As used herein, the term “connected” may be construed as “electrically connected,” and the term “coupled” may also be construed as “electrically coupled.” “Connected” and “coupled” may also be used to indicate that two or more elements cooperate or interact with each other.

As used herein, although the terms such as “first,” “second” and “third” describe various elements, components, regions, layers and/or sections, these elements, components, regions, layers and/or sections should not be limited by these terms. These terms may be only used to distinguish one element, component, region, layer or section from another. The terms such as “first,” “second” and “third” when used herein do not imply a sequence or order unless clearly indicated by the context.

The electronics industry has experienced an ever-increasing demand for smaller and faster electronic devices that are simultaneously able to support a greater number of increasingly complex and sophisticated functions. To meet these demands, there is a continuing trend in the integrated circuit (IC) industry to manufacture low-cost, high-performance, and low-power ICs. Efforts have been spent to achieve these goals largely by reducing IC dimensions (for example, minimum IC feature size), thereby improving device performance and lowering associated costs. However, when the approaches using the electronic engineering have approached their physical limits, the improvement may not be attained as fast as before.

One of the major issues shared by most of the existing electronic circuits is the ever-increasing power consumption used in computing-intensive applications, e.g., artificial intelligence, deep learning, and machine learning, which are required to performing high-volume data computation in a short period of time. Such a computation framework is generally implemented to emulate a neural network, e.g., convolutional neural network (CNN), deep neural network (DNN) and photonics neural network (PNN), constructed by a plurality of computation units, referred to herein as multiply-accumulate (MAC) unit. The more MAC units the computing-intensive device can leverage, the faster or the more computation tasks it can be achieved. However, the highly increasing power consumption of the computing-intensive device formed of the MAC units would frustrate the application and popularity of the computing-intensive semiconductor devices.

In this regard, efforts have been made to implement optical computing in an optical/photonic device in place of the electronics-based MAC units, in which the input activations of a neural network are realized by a plurality of optical beams, the weights of the neural network are realized by a filtering operation of one or more spatial light modulator (SLM), and the output activations of the neural network are realized by a plurality of photodetectors. The energy consumption of optical computing for performing the MAC operations is therefore greatly reduced. However, the footprint occupied by the optical components for realizing the neural network operations may impose challenges to the trend of size reduction in the modern semiconductor devices. Therefore, it is desirable to devise the optical circuit with a relatively compact structure.

In order to address the abovementioned issues, the present disclosure discloses an optical receiver framework by leveraging a time-division approach to extract the multiple optical signals in different time periods, in which the multiple optical signals are transmitted in different wavelengths of a combined optical signal. The optical signals are partitioned into several groups of optical signals of a uniform group size, and a wavelength-division demultiplexer (WDDeM) is used to extract each group of optical signals in the corresponding time period with the operating wavelengths of the WDDeM tuned to those of the optical signals in the respective group. As a result, the footprint of the WDDeM can be reduced by several-folds due to reuse of the WDDeM. Thus, the device size of the overall circuit for implementing the optical computing architecture can be decreased due to the size reduction of the WDDeM.

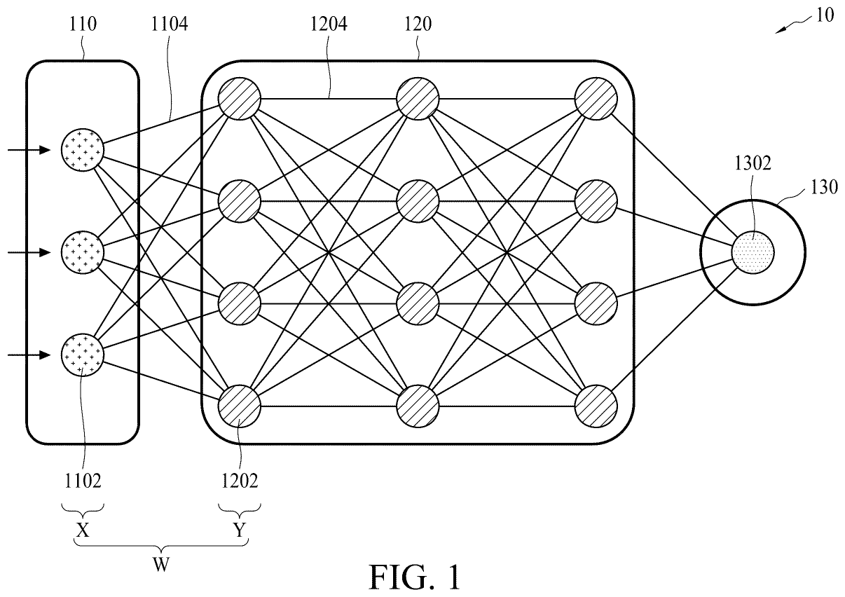

FIG. 1 illustrates a block diagram of a model of a neural network 10, in accordance with some embodiments. As can be seen in FIG. 1, the neural network 10 is formed of a mesh-like interconnection structure and includes an input layer 110, a plurality of inner layers 120 (or hidden layers), and an output layer 130. In the depicted example shown in FIG. 1, the input layer 110 or each of the inner layers 120 includes a plurality of neurons (or nodes) 1102 or 1202, and only one neuron 1302 is present in the output layer 130. The neurons 1102 and 1202 in the respective input layer 110 and the first inner layer 120 or neurons 1202 in adjacent inner layers 120 are interconnected with interconnections 1104 or 1204 having corresponding weights, which are set according to the influence or effect that the preceding neuron 1102 or 1202 in a preceding layer 110 or 120 is to make on the subsequent neuron 1202 or 1302 in the next inner layer 120 or the output layer 130. The output value of the preceding neuron 1102 or 1202 is multiplied by the weight of its interconnection 1104 or 1204 to the subsequent neuron 1202 or 1302 to determine the particular stimulus that the preceding neuron 1102 or 1202 is to exert on the subsequent neuron 1202 or 1302.

Referring to FIG. 1, the MAC operations occur when the stimuli are exerted from neurons in a preceding layer 110 or 120 toward a next layer 120 or 130. An exemplary MAC operation between the input layer 110 and the first inner layer 120 can be represented by a 1-by-K vector of input values X in the input layer 110, a K-by-N weight matrix W₁, and a 1-by-N vector of output values Y in the first inner layer 120, wherein K and N are natural numbers. The MAC operation for a vector-matrix multiplication operation can therefore be expressed by a matrix representation as Equation (1) shown below.

$$\begin{matrix}{X}_{1 \times K} {W}_{K \times N} = [ {X}_{1 , 1} {X}_{1 , 2} ¨ {X}_{1 , K} ¨ {X}_{1 , K} ] [ \begin{matrix}{W}_{1 , 1} & {W}_{1 , 2} & ¨ & {W}_{1 , n} & ¨ & {W}_{1 , N} \\ {W}_{2 , 1} & & & & & \\ … & & & & & \\ {W}_{k , 1} & & & {W}_{k , N} & & \\ ¨ & & & & & \\ {W}_{K , 1} & & & & & {W}_{K , N}\end{matrix} ] \\ \begin{matrix}= [ {X}_{1} \cdot {W}_{1} {X}_{1} \cdot {W}_{2} ¨ {X}_{1} \cdot {W}_{n} ¨ {X}_{1} \cdot {W}_{N} ] \\ = [ {Y}_{1 , 1} {Y}_{1 , 2} ¨ {Y}_{1 , n} ¨ {Y}_{1 , N} ] \\ = {Y}_{1 \times N}\end{matrix}\end{matrix} \qquad ( 1 )$$

The above MAC operation may occur in any pair of adjacent inner layers 120, in which the weight matrix W is represented as an N-by-N array. Further, the MAC operation occurring between the last inner layer 120 and the output layer 130 can be expressed by Equation (1), in which the weight matrix W is represented as an N-by-1 vector, and the output value Y includes only a scalar value.

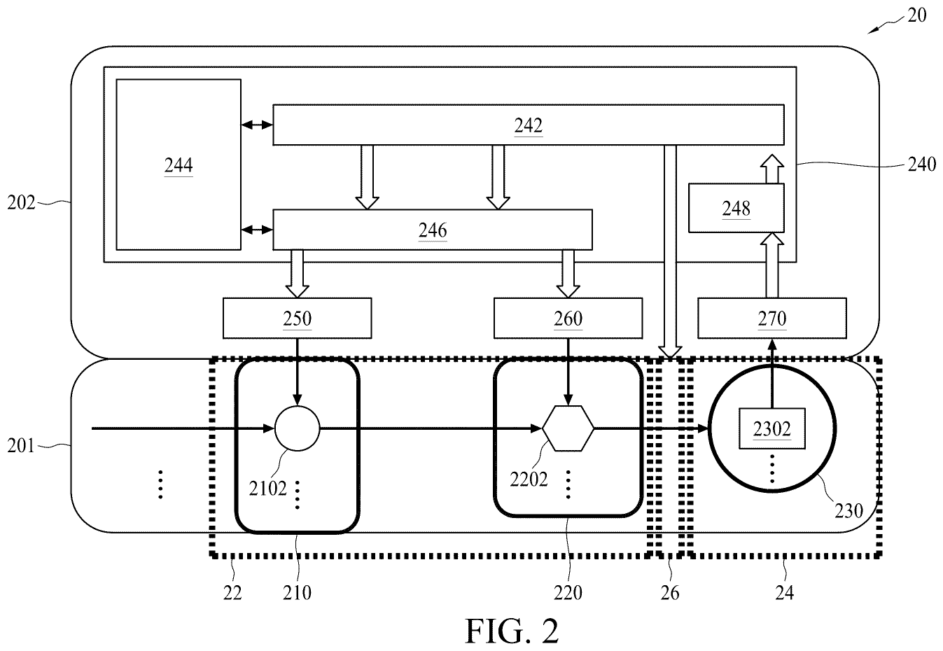

FIG. 2 illustrates a block diagram of a semiconductor device 20 for implementing the neural network 10 shown in FIG. 1, in accordance with some embodiments of the present disclosure. The semiconductor device 20 includes an optical device 201 (also referred to herein as an optical die or a photonic integrated circuit, PIC) and an electrical device 202 (also referred to herein as an electrical IC, EIC). The optical device 201 is bonded to the electrical device 202, e.g., through a plurality of bonding elements (not separately shown).

According to some embodiments, the optical device 201 includes an optical transmitter 22 and an optical receiver 24. The optical transmitter 22 and the optical receiver 24 may be connected through an optical channel 26. The optical transmitter 22 may include an input layer 210 and an inner layer 220 corresponding to the input layer 110 and the inner layers 220, respectively, of the neural network 10 shown in FIG. 1. Further, the optical receiver 24 includes an output layer 230 corresponding to the output layer 130 of the neural network 10 shown in FIG. 1. The input layer 210 includes a plurality of input modulators 2102 corresponding to the input values (neurons) 1102 of the input layer 110 shown in FIG. 1, and the inner layer 220 includes a plurality of weight modulators 2202 corresponding to the weights of the interconnections 1104 and 1204 in the input layer 110 or inner layers 120 shown in FIG. 1. Additionally, the optical receiver 24 may include a plurality of photodetectors (PD) 2302 configured to convert optical signals transmitted from the inner layers 220 into electrical signals and constitute part of the output layer 130 shown in FIG. 1. FIG. 2 only shows one exemplary input modulator 2102, one exemplary weight modulator 2202, and one exemplary photodetector 2302 for simplicity, but the present disclosure is not limited thereto.

According to some embodiments, the electrical device 202 includes a controller 240, a plurality of first digital-to-analog convertors (DACs) 250, a plurality of second DACs 260, and a plurality of analog-to-digital convertors (ADCs) 270. FIG. 2 only shows one exemplary first DAC, one exemplary second DAC 260, and one exemplary ADC 270 for simplicity, but the present disclosure is not limited thereto. According to some embodiments, the controller 240 includes a processing unit 242, a memory device 244, a signal buffer 246 and a comparator 248.

According to some embodiments, the memory device 244 stores model parameters of the neural network 10, e.g., the model type of the neural network 10, the numbers K and N, the input values of the input layer 110 and the weighting values of the inner layers 120. During operation, the processing unit 242 is configured to access the model parameters from the memory device 244 and transmit the model parameters to the first plurality of DACs 250 and the second plurality of DACs 260 for converting these parameters to analog electrical signals based on their digital counterparts. The converted electrical signals at the outputs of the first plurality of DACs 250 and the second plurality of DACs 260 are fed into the input modulators 2102 and the weight modulators 2202, respectively, of the optical transmitter 22. Meanwhile, a plurality of optical beams or signals are generated by an optical source (not separately shown) of the optical device 201 and transmitted to the plurality of input modulators 2102. The optical signals may be modulated to a predetermined wavelength λ. Accordingly, the input modulators 2102 and the weight modulators 2202 are configured to enable the MAC operations with the input and output signals in an optical form, and the control (modulating) signals are provided by the electrical signals from the first plurality of DACs 250 and the second plurality of DACs 260.

After the optical signals for the MAC operations travel through the input layer 210 and the inner layers 220 of the optical transmitter 22, these optical signals are to be provided to the optical receiver 24. Referring to FIG. 1 and FIG. 2, the number of neurons 1202 in the last inner layer 120 is N, and thus the number of the optical signals at the output of the optical transmitter 22 is also N for representing the last inner layer 120. According to some embodiments, these N optical signals are multiplexed into the optical channel 26 in a combined optical signal, in which each optical signal is modulated to a predetermined wavelength in the combined optical signal. According to some embodiments, the optical channel 26 may be constructed with an optical waveguide or an optical fiber configured to carry one or more optical signals in different wavelengths. Although not separately shown, the optical device 201 includes a wavelength-division multiplexer (WDM) between the optical transmitter 22 and the optical channel 26 and configured to perform wavelength-division multiplexing of the N optical signals for forming the combined optical signal before they are sent to the optical channel 26.

According to some embodiments, the combined optical signal is transmitted to the optical receiver 24 from the optical channel 26 and demultiplexed to N received optical signals. The N received optical signals are further converted into N electrical signals by respective photodetectors 2302. According to some embodiments, the photodetectors 2302 may be formed of photodiodes or other similar opto-electrical converters. The outputs of the photodetectors 2302 may be in the form of electrical currents, and are transmitted to the electrical device 202, in which the electrical current signals are fed into the plurality of ADCs 270. The ADCs 270 are configured to convert analog electrical signals into their digital counterparts. According to some embodiments, the electrical device 202 further includes a plurality of transimpedance amplifiers (TIAs) at the inputs of the ADCs 270 and configured to convert the current signals at the outputs of the photodetectors 2303 into voltage signals. The voltage signals may be fed to the ADCs 270 to generate N digital receiver values representing the N optical signals generated by the optical transmitter 22. The N receiver values are subsequently transmitted to the comparator 248, which is configured to perform data comparison to select a maximal (or minimal) value among the input values as the comparison result and provide this comparison result to the processing unit 242. As such, the optical receiver 24, the ADCs 270 and the comparator 248 (may also include the TIAs) together form the output layer 130 of the neural network 10 shown in FIG. 1.

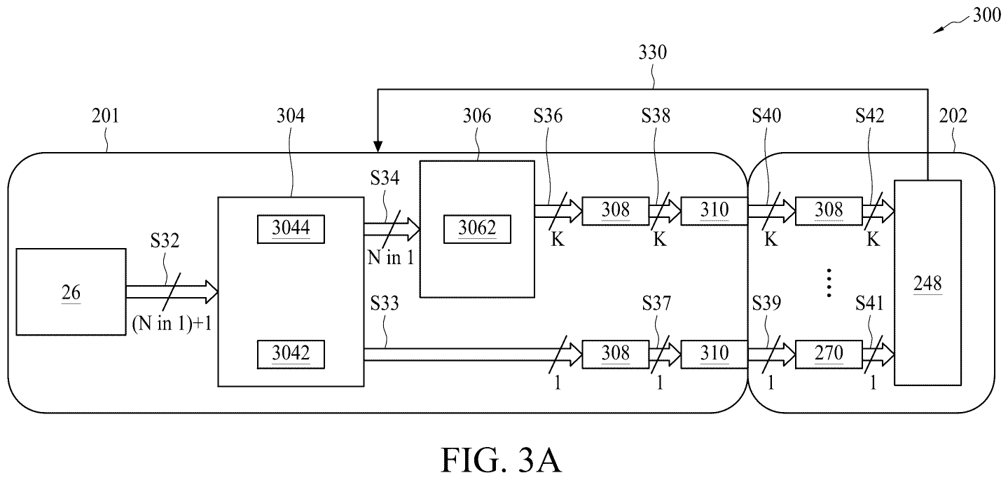

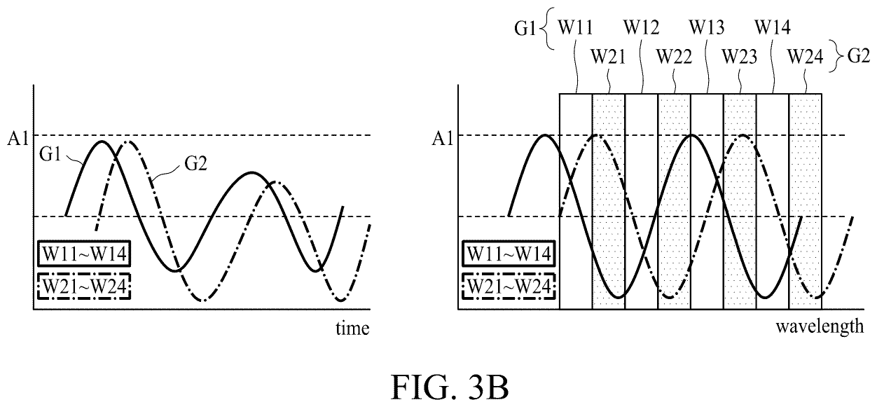

FIG. 3A illustrates a block diagram of a multichannel receiver 300 of the semiconductor device 20, in accordance with some embodiments of the present disclosure. The multichannel receiver 300 is used to implement the output layer 130 of the neural network 10 shown in FIG. 1, and may cover the optical receiver 24 of the optical device 201 as well as the ADCs 270 and the comparator 248 of the electrical device 202 shown in FIG. 2. According to some embodiments, referring to FIG. 3A, the multichannel receiver 300 receives a combined optical signal S32 including multiple component optical signals in multiple channels (wavelengths) and includes, in the optical device 201, a power splitter 304, a WDDeM 306, a plurality of phase shifter 308 and a plurality of photodetectors 310. Further, according to some embodiments, the multichannel receiver 300 includes, in the electrical device 202, a plurality of ADCs 270 and a comparator 248.

According to some embodiments, the power splitter 304 includes a reference signal filtering module 3042 and a power adjustment module 3044. According to some embodiments, the WDDeM 306 includes an MZI 3062. During operation, the multichannel receiver 300 receives the combined optical signal S32 from the optical channel 26, e.g., an optical waveguide, an optical fiber, or the like. The combined optical signal S32 carries N (data-containing) optical signals S36 modulated at different wavelengths. According to some embodiments, the combined optical signal S32 further includes a reference optical signal S33 modulated at a wavelength different from the wavelengths where the optical signals S36 reside. The N optical signals S36 can be filtered out collectively as a data-only combined optical signal S34. Thus, the combined optical signal S32 and the data-only combined optical signal S34 are referred to as an (N in 1)+1 optical signal and an (N in 1) optical signal, respectively, as labelled in FIG. 3A. The reference optical signal S33 may be used at the receiving end to provide a reference level of a signal amplitude or power for the logic state ‘1’ embedded in optical signals S36 of the data-only combined optical signal S34. The power splitter 304 or the WDDeM 306 may need formation of the reference signal level to extract signals with a proper amplitude during power splitting or demodulation of the data-only combined optical signal S34.

FIG. 3B shows signal waveforms and spectral responses of the data-only combined optical signal 34, in accordance with some embodiments of the present disclosure. In the depicted example, a channel number N, i.e., the number of the optical signals S36 embedded in the data-only combined optical signal 34, is set as eight, and these optical signals S36 are divided into two groups each including four optical signals S36. For convenience of recognition of these optical signals S36, they are identified with wavelengths W11, W12, W13, and W14 for the first group G1 and wavelengths W21, W22, W23, and W24 for the second group G2. Referring to a left subfigure of FIG. 3B, a chart shows two signal waveforms of combined optical signals in the two groups G1 and G2, respectively, fluctuating in time domain. Referring to a right subfigure of FIG. 3B, a spectral response shows eight spectral regions for the respective eight optical signals S36. Each optical signal S36 includes an amplitude that carries information of data, e.g., in a form of a logic state ‘1’ or ‘0’ in a binary data system. The amplitudes of the optical signals S36 may exhibit stable distributions which fall on the vicinity of two levels representing logic states ‘1’ and logic ‘0’, while the time-domain waveforms of the combined optical signals may exhibit a more fluctuating amplitude due to the summation of optical signals with different wavelengths. In the depicted example, the four spectral regions of the first group G1 is alternatingly arranged with the spectral regions of the second group G2. However, the present disclosure is not limited thereto.

According to some embodiments, the reference signal filtering module 3042 is configured to generate the reference optical signal S33 separately from the data-only combined optical signals S34. The reference optical signal S33 may be originally modulated to a relatively large wavelength than that of the combined optical signal S32, and thus the reference signal filtering module 3042 may include a longpass filter configured to extract the reference optical signal S33 from the combined optical signal S32. According to some embodiments, the longpass filter includes a WDM-based filter, such as a WDM device based on a Mach-Zehnder interferometer (MZI) or a micro-ring resonator (MRR), serving as an optical filter for extracting the reference optical signal S33.

According to some embodiments, the power of the combined optical signal S32 may change or fluctuate after transmission over the optical channel 26. Therefore, it is desirable to tune the amplitude or power of the combined optical signal S32 back to its original value through help of the reference optical signal S33.

According to some embodiments, the power adjustment module 3044 is configured to generate the data-only combined optical signal S34 with an adjusted amplitude or power from the combined optical signal S32. The power adjustment module 3044 may include a directional coupler or a multimode interferometer (MMI) for performing power adjustment of the combined optical signal S32. For example, an MZI is used for performing power adjustment on the combined optical signal S32.

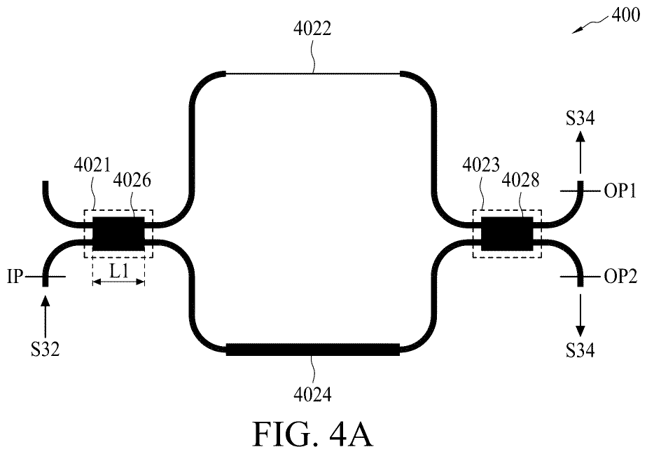

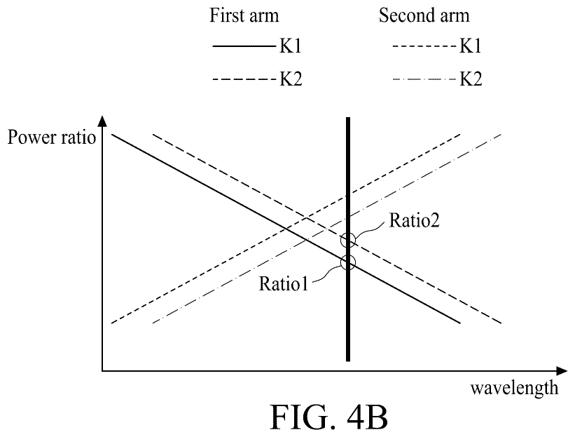

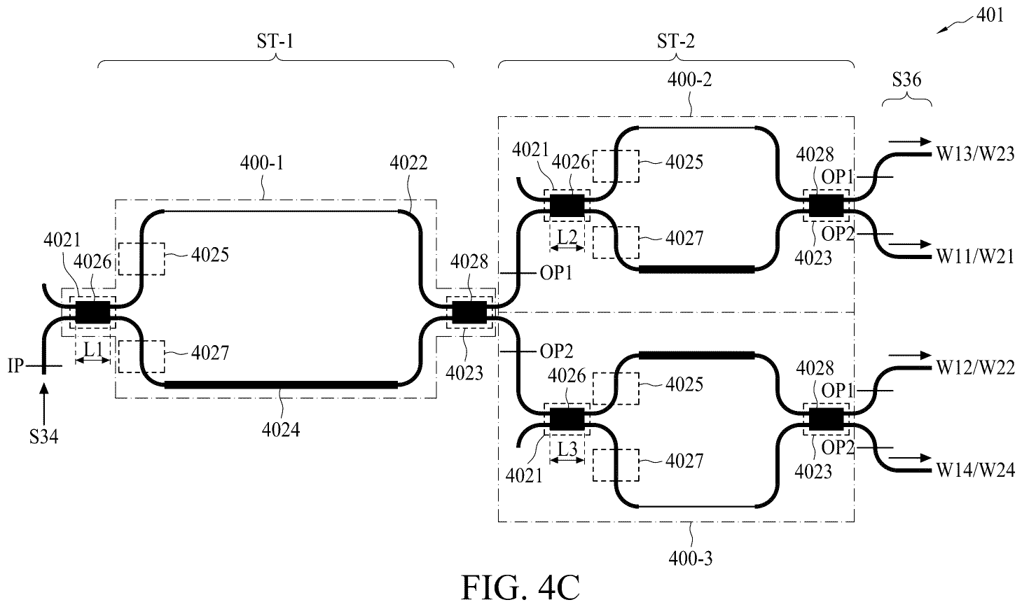

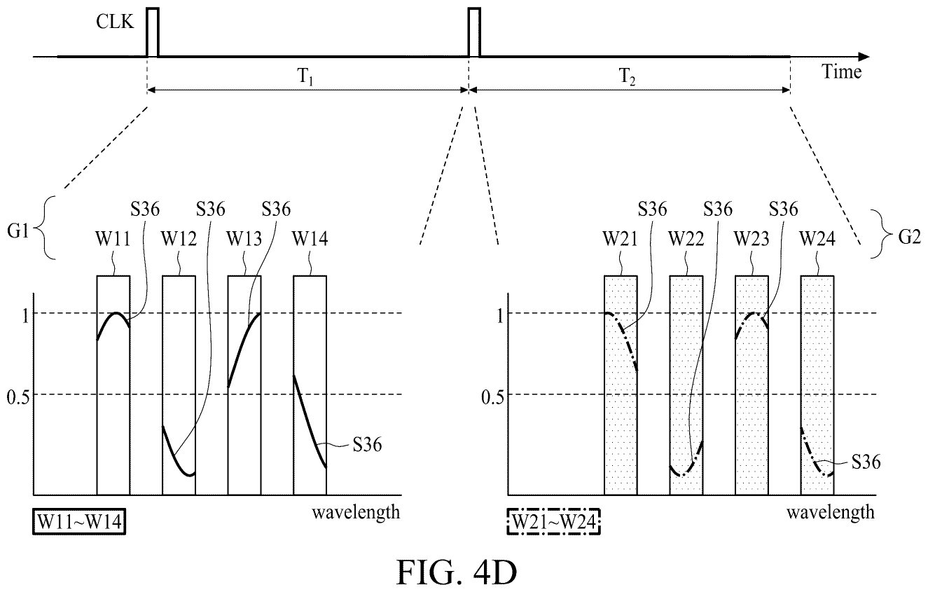

FIG. 4A shows a block diagram of a single-stage MZI 400, in accordance with some embodiments of the present disclosure. The MZI 400 may be used to implement the power adjustment module 3044 shown in FIG. 3A. According to some embodiments, the MZI 400 includes a first arm 4022, a second arm 4024, a first optical coupler 4026 and a second optical coupler 4028. The first arm 4022, the second arm 4024, the first optical coupler 4026 and the second optical coupler 4028 are formed of a material of an optical waveguide or an optical fiber, such as bulk silicon or silicon nitride. The MZI 400 further includes an input port IP and two output ports OP1 and OP2 at the input end of the second arm 4024 and the output ends of the first arm 4022 and second arm 4024, respectively.

The first input port IP is configured to receive the combined optical signals S32, while the output port OP1 and OP2 are configured to output the data-only combined optical signals S34 with different power levels. The optical couplers 2046 and 2048 are designed to include a length L1 in the direction in which the combined optical signal S32 propagate for filtering the data-only combined optical signal S34 of the desired wavelengths. Further, the first arm 4022 and the second arm 4024 may have different arm lengths to conduct optical interference, which causes phase shifting to facilitate wavelength tuning and signal power distribution. According to some embodiments, the MZI 400 additionally includes a first power modulator 4021 around the first optical coupler 4026 and a second power modulator 4023 around the second optical coupler 4028. The first power modulator 4021 and the second power modulator 4023 may be heated to a predetermined temperature or appropriately biased to a voltage for changing the refractive index of the first optical coupler 4026 and the second optical coupler 4028, thereby adjusting the power distributions in the first arm 4022 and the second arm 4024. The temperature of the heated first optical coupler 4026 (similarly for the heated second optical coupler 4028) may be different according to the desired power ratios. Through the adjustment of the first power modulator 4021 and the second power modulator 4023, the power ratio of the data-only combined optical signal S34 in the first arm 4022 and the second arm 4024 can be controlled as desired.

FIG. 4B shows a chart illustrating power distributions in the two arms 4022 and 4024 of the MZI 400, in accordance with some embodiments of the present disclosure. Referring to FIG. 4A and FIG. 4B, the input port IP of the MZI 400 receives the combined optical signal S32 into the second arm 4024. The combined optical signal S32 includes, for example, (component) optical signals S36 in the first group G1 with wavelengths W11, W12, W13 and W14 and the second group G2 with wavelengths W21, W22, W23 and W24. Through appropriate control of the length L1 and the refractive index of the first optical coupler 4026 and the second optical coupler 4028, the power ratio of the combined optical signal S32 in the first arm 4022 to the second arm 4024 can be well managed. Referring to FIG. 4B, the solid line and the dashed line represent the powers of the combined optical signal S32 in the first arm 4022 at different temperatures K1 and K2, respectively, of the first or second optical coupler 4026 or 4028, in which the temperature K1 or K2 correspond to different refractive indices of the first or second optical coupler 4026 or 4028. Similarly, the dotted line and the dash-dotted line represent the powers of the combined optical signal S32 in the second arm 4024 at different temperatures K1 and K2, respectively, of the first or second optical coupler 4026 or 4028.

The chart of FIG. 4B shows that, for a given temperature K1 or K2, the power sum of the combined optical signal S32 or the data-only combined optical signal 34 in the first arm 4022 and the second arm 4024 is kept unchanged. In other words, the sum of the solid line and the dotted line given any specific wavelength is always equal to a fixed power level, or 100% in terms of percentage under a fixed temperature K1. Likewise, under a fixed temperature K2, the sum of the dashed line and the dash-dotted line given any specific wavelength is always equal to a fixed power level, or 100% in terms of percentage. However, the power ratio of the first arm 4022 to the second arm 4024 may change from Ratio 1 to Ratio 2 when the temperature is changed from K1 to K2. According to some embodiments, the temperature K2 is greater than K1, and the power percentage of the combined optical signal S32 or the data-only combined optical signal 34 in the first arm 4022 increases with the increase of the temperature from K1 to K2, while the power percentage of the combined optical signal S32 or the data-only combined optical signal 34 in the second arm 4024 decreases at the same time. Through temperature control in the first and second optical couplers 4026 and 4028, the refractive index of the first and second optical couplers 4026 and 4028 changes accordingly, and thus the power distribution at the first output port OP1 and the second output port OP2 can be adjusted. According to some embodiments, only the optical signal S34 at one of the first output port OP1 or the second output port OP2 is left as the power-adjusted data-only combined optical signal S34 and serve as the input signal of the WDDeM 306.

FIG. 4C shows a block diagram of a two-stage MZI 401, in accordance with some embodiments of the present disclosure. The two-stage MZI 401 is only an illustrative example of the MZI 3062 or the WDDeM 306, but the WDDeM 306 can be alternatively realized with other types of optical devices, such as an MRR. Further, although FIG. 4C only shows a two-stage MZI 401, the MZI 401 formed of other number of stages more than two is also within the contemplated scope of the present disclosure.

Referring to FIG. 4C, the MZI 401 is formed of two stages ST-1 and ST-2, in which the first stage ST-1 includes a single MZI unit 400-1, which is similar to the MZI 400 shown in FIG. 4A, and the second stage ST-2 includes two MZI units 400-2 and 400-3 adjacent to one another. The input port IP at the lower arm 4024 of the upper MZI 400-2 in the second stage ST-2 is optically coupled to the first output port OP1 of the MZI unit 400-1, and the input port IP at the upper arm 4022 of the lower MZI 400-3 in the second stage ST-2 is optically coupled to the second output port OP2 of the MZI unit 400-1.

According to some embodiments, the optical couplers 2046 and 2048 of the MZI unit 400-1 are designed to include a length L1 for extracting the target optical signals of desired wavelengths W11, W12, W13 and W14. Further, the optical couplers 2046 and 2048 of the MZI unit 400-2 are designed to include a length L2 for extracting the target optical signals of desired wavelengths W11 and W13. Likewise, the optical couplers 2046 and 2048 of each of the MZI unit 400-3 are designed to include a length L3 for extracting the target optical signals of desired wavelengths W12 and W14.

According to some embodiments, the optical couplers 2046 and 2048 of the MZI unit 400-1 are designed to include the length L1 for extracting the target optical signals of desired wavelengths W21, W22, W23 and W24. Further, the optical couplers 2046 and 2048 of the MZI unit 400-2 are designed to include the length L2 for extracting the target optical signals of desired wavelengths W21 and W23. Likewise, the optical couplers 2046 and 2048 of each of the MZI unit 400-3 are designed to include the length L3 for extracting the target optical signals of desired wavelengths W22 and W24.

According to some embodiments, the first arm 4022 and the second arm 4024 in the MZI unit 400-2 or 400-3 may have different arm lengths to facilitate optical coupling and signal power distribution. According to some embodiments, each MZI unit 400-1, 400-2 and 400-3 additionally includes a first wavelength modulator 4025 and a second wavelength modulator 4027 in the respectively first arm 4022 and second arm 4024. The first wavelength modulator 4025 or the second wavelength modulator 4027 may be formed to be coupled to the first arm 4022 or the second arm 4024, respectively, midway between the first optical coupler 4026 and the second optical coupler 4028. For example, the first wavelength modulator 4025 or the second wavelength modulator 4027 is arranged on a first vertical section of the respective first arm 4022 or the second arm 4024.

The first wavelength modulator 4025 or the second wavelength modulator 4027 may be heated to a predetermined temperature or appropriately biased to a predetermined voltage in order to change the refractive index of the first arm 4022 or the second arm 4024, thereby adjusting the wavelengths of the data-only combined optical signal S34 that can pass through the first arm 4022 or the second arm 4024. As a result, according to some embodiments, the upper arm 4022 of the MZI unit 400-1 allow the data-only combined optical signal S34 of wavelengths W11 and W13 to pass through, while the lower arm 4024 of the MZI unit 400-1 allow the data-only combined optical signal S34 of wavelengths W12 and W14 to pass through. Moreover, the upper arm 4022 of the MZI unit 400-2 allow the data-only combined optical signal S34 of wavelength W13 to pass through to form one of the (component) optical signals S36, while the lower arm 4024 of the MZI unit 400-2 allow the data-only combined optical signal S34 of wavelengths W11 to pass through to form one of the optical signals S36. Likewise, the upper arm 4022 of the MZI unit 400-3 allow the data-only combined optical signal S34 of wavelength W12 to pass through to form one of the optical signals S36, while the lower arm 4024 of the MZI unit 400-3 allow the data-only combined optical signal S34 of wavelengths W14 to pass through to form one of the optical signals S36.

According to some embodiments, the upper arm 4022 of the MZI unit 400-1 allow the data-only combined optical signal S34 of wavelengths W21 and W23 to pass through, while the lower arm 4024 of the MZI unit 400-1 allow the data-only combined optical signal S34 of wavelengths W22 and W24 to pass through. Moreover, the upper arm 4022 of the MZI unit 400-2 allow the data-only combined optical signal S34 of wavelength W23 to pass through to form one of the optical signals S36, while the lower arm 4024 of the MZI unit 400-2 allow the data-only combined optical signal S34 of wavelengths W21 to pass through to form one of the optical signals S36. Likewise, the upper arm 4022 of the MZI unit 400-3 allow the data-only combined optical signal S34 of wavelength W22 to pass through to form one of the optical signals S36, while the lower arm 4024 of the MZI unit 400-3 allow the data-only combined optical signal S34 of wavelengths W24 to pass through to form one of the optical signals S36.

In the depicted example, the four optical signals S36 of the first group G1 or the second group G2 included in the data-only combined optical signal S34 are extracted individually to be four separate optical signals S36 by the two-stage MZI 401. The MZI 3062 or 401 accomplishes the wavelength-domain demultiplexing of the data-only combined optical signal S34.

As discussed previously, the total number N, say eight, of the optical signals S36 is greater than a number K, say four, of the output signals of the MZI 401 according to some embodiments. The number N is a multiple of the number K, or equivalently, the number K is an integer factor of the number N. That way, the optical signals S36 can be partitioned into several groups, e.g., the first group G1 and the second group G2, and be demultiplexed by the MZI 401 in different time periods. FIG. 4D shows a block diagram of time-division and wavelength-division demultiplexing of the data-only combined optical signal S34, in accordance with some embodiments of the present disclosure. The depicted example explained with reference to FIG. 4D follows the examples shown with reference to FIGS. 3A, 3B, 4A, 4B and 4C with N and K set as eight and four, respectively. According to some embodiments, the combined optical signal S32 is repeatedly transmitted through the power splitter 304 in at least two processing time periods T₁ and T₂. The processing time periods T₁ and T₂ may be controlled and signaled via an electrical clock signal CLK transmitted to the optical device 201 by the processing unit 242 through a signal line 330 shown in FIG. 3A. The length of the time period T₁ or T₂ may be adjustable based on the processing time that is spent by the MZI 3062 or 401 to complete a signal demultiplexing routine. According to some embodiments, the lengths of the time periods T₁ and T₂ are substantially equal.

During operation, the WDDeM 306 or the MZI 3062 is configured to extract the optical signals S36 in the first group G1, in which during the first time period T₁, the first wavelength modulators 4025 and the second wavelength modulators 4027 in the MZI 401 are tuned to select the desired wavelengths of W11, W12, W13 and W14 such that the four optical signals S36 in the first group G1 are extracted and generated individually at the four output ports of the MZI 401, i.e., the output ports OP1, OP2 of the MZI units 400-2 and 400-3. Subsequently, during the second time period T₂, the wavelength modulators 4025 and 4027 in the MZI 401 is tuned to select the desired wavelengths of W21, W22, W23 and W24 such that the four optical signals S36 in the second group G2 are extracted and generated individually at the four output ports OP1, OP2 of the MZI 401.

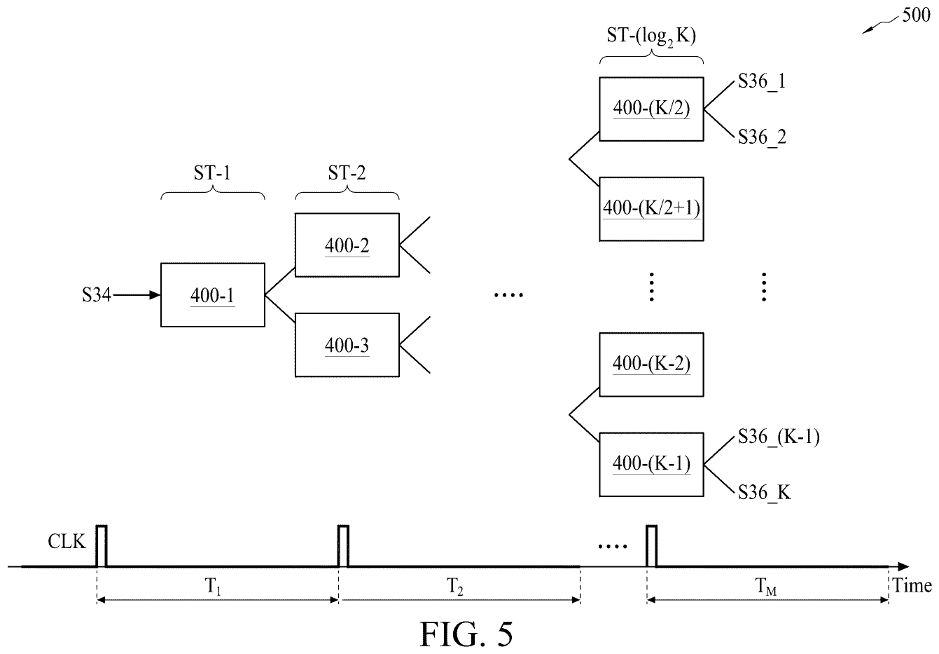

FIG. 5 shows a block diagram of a generalized MZI 500, in accordance with some embodiments of the present disclosure. The MZI 500 can be seen a generalization of an MZI in the number L of stages ST-1 (1<=1<=L) and the number K of the optical signals S36 that are generated at one time at the output ports of an MZI. 500.

Referring to FIG. 4D and FIG. 5, assume that the data-only combined optical signal S34 carries N optical signals S36 at different wavelengths, and that the demultiplexing task is performed in a time-domain multiplexing approach, in which K optical signals are demultiplexed by the MZI 500 during one processing time period. Assume that the equation holds: N=K×M. Therefore, it will take the time periods of T₁, T₂, . . . , T_{M}, or M times of the processing time period T₁ to perform demultiplexing of K optical signals S36 in each time period until all of the N optical signals S36 are demultiplexed from the data-only combined optical signal S34 and generated individually.

Each stage, e.g., stages ST-1, ST-2, . . . , ST-M, of the MZI 500 includes K−1 MZI units 400-h in each stage ST-m, among the overall MZI units, where the integers h=1, 2, . . . , K−1, 1=1, 2, . . . , M, and the integer M=log₂K. As a result, the proposed time-multiplexed WDDeM framework with the MZI 500 can be tailored to different application requirements with various limits on the processing time and device size of the WDDeM 306. Each of the MZI units 400-h may have similar structure and features, just like the MZI 400 shown in FIG. 4A. However, in order to accomplish demultiplexing of optical signals S36 modulated at different wavelengths, the lengths Lh and target wavelengths of the first power modulator 4021 and the second power modulator 4023 may differ from one another, and the first wavelength modulator 4025 and the second wavelength modulator 4027 of the MZI unit 400-m may be tuned to respective target wavelengths.

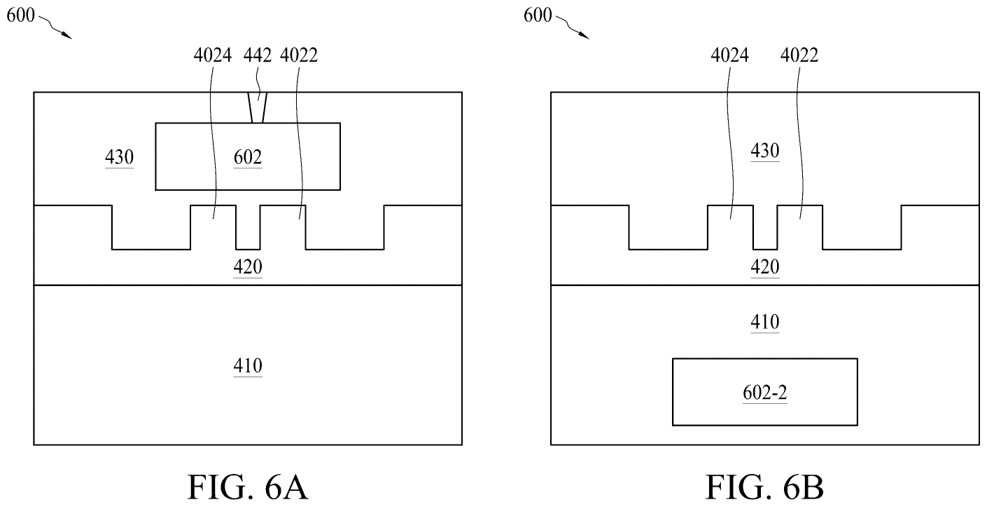

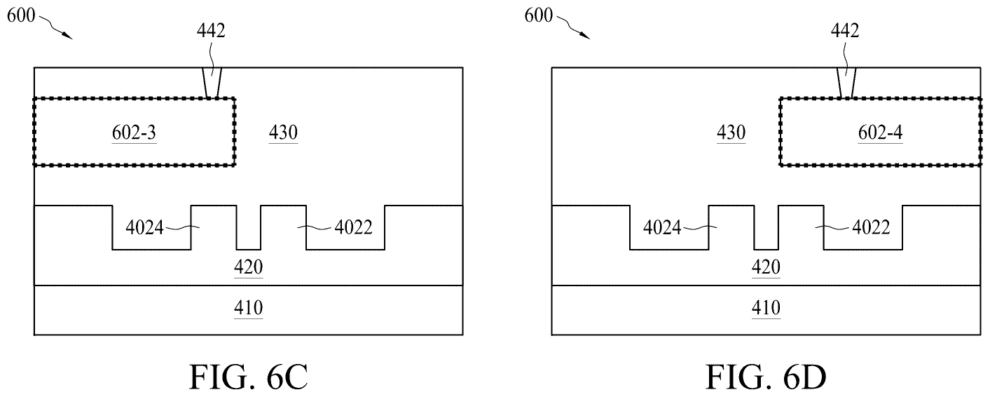

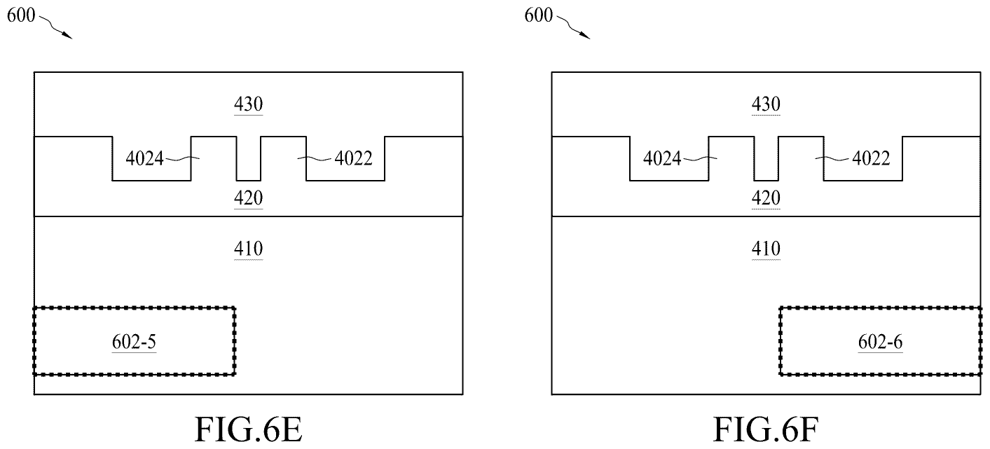

FIGS. 6A, 6B, 6C, 6D, 6E and 6F show block diagrams of cross-sectional views of an MZI 600, in accordance with some embodiments of the present disclosure. The MZI 600 is similar to the MZI 400 or 401 shown in FIG. 4A or 4C, respectively. The cross-sectional views are taken from a section line traversing one of the first optical coupler 4026, the second optical coupler 4028, the first wavelength modulator 4025 and the second wavelength modulator 4027. According to some embodiments, the MZI 600 includes a first insulating layer 410, a substrate 420 and a second insulating layer 430. The MZI 600 further includes one or more optical waveguides, e.g., a first arm 4022 and a second arm 4024, arranged on a central portion of the substrate 420. According to some embodiments, the first insulating layer 410 and the second insulating layer 430 include a dielectric material, such as silicon oxide or the like, and serve as a cladding layer of the optical waveguide of the MZI 600, e.g., the first arm 4022 and the second arm 4024.

According to some embodiments, the MZI 600 further includes a heater modulator arranged over the first arm 4022 and the second arm 4024. The heater modulator may include a resistive element 602-1, 602-2, 602-3, 602-4, 602-5 and 602-6 shown in FIGS. 6A to 6F, respectively, and is used to implement the first power modulator 4021, the second power modulator 4023, the first wavelength modulator 4025 and the second wavelength modulator 4027. Referring to FIG. 6A, the resistive element 602-1 functions as a heater in the MZI 600 and configured to heat the underlying first arm 4022 and/or the second arm 4024 when the resistive element 602-1 is used as the first power modulator 4021 or the second power modulator 4023. The resistive element 602-1 may be formed of a conductive material, such as doped silicon or metallic materials, e.g., copper, aluminum, titanium, titanium nitride, and the like. Moreover, the MZI 600 further includes a conductive via 442 electrically coupled to the resistive element 602-1 and configured to provide electrical energy to the resistive element 602-1, where the electrical energy is transformed into thermal energy by the resistive element 602-1. When the first arm 4022 and/or the second arm 4024 are heated by the heater modulator or the resistive element 602-1, the optical coupling performance between the first arm 4022 and the second arm 4024 is changed accordingly, and the power distribution in the first arm 4022 and the second arm 4024, or the selected wavelength in the first arm 4022 or the second arm 4024, will change accordingly, in which whether the power distribution changes or the selected wavelength changes depends on the arranged location of the resistive element 602-1. Although FIGS. 6A to 6F only show the cross-sectional views around the first power modulator 4021 or the second power modulator 4023 where both of the first arm 4022 and the second arm 4024 are present, the disclosure is not limited thereto. The arrangement of the resistive element 602-1 shown in FIGS. 6A to 6F also applies to the first wavelength modulator 4025 and the second wavelength modulator 4027 where only one of the first arm 4022 and the second arm 4024 is present around the resistive element 602-1.

According to some embodiments, the resistive element 602-1 is arranged directly over the first arm 4022 or the second arm 4024. According to some embodiments, referring to FIG. 4A and FIG. 6A, the resistive element 602-1 is arranged directly over the first optical coupler 4026 or the second optical coupler 4028. The resistive element 602-1 may overlap an entirety of the first optical coupler 4026 or the second optical coupler 4028 from a top-view perspective. The resistive element 602-1 is close to but separated from the first arm 4022 or the second arm 4024 by the second insulating layer 430.

According to some embodiments, the temperatures arrived at by the heater modulator used on the first power modulator 4021 or the second power modulator 4023 may be different for different desired power ratios of the first optical coupler 4026 or the second optical coupler 4028. Likewise, the temperatures arrive at by the heater modulator used on the first wavelength modulator 4025 or the second wavelength modulator 4027 may be different for different desired wavelengths to be demultiplexed.

Referring to FIG. 6B, a resistive element 602-2 is arranged directly below the first arm 4022 or the second arm 4024. According to some embodiments, referring to FIG. 4A and FIG. 6B, the resistive element 602-2 is arranged directly below the first optical coupler 4026 or the second optical coupler 4028. The resistive element 602-2 may overlap an entirety of the first optical coupler 4026 or the second optical coupler 4028 from a top-view perspective. The resistive element 602-2 is close to but separated from the first arm 4022 or the second arm 4024 by the first insulating layer 410. The resistive element 602-2 may have a material similar to the resistive element 602-1.

Referring to FIG. 6C and FIG. 6D, a resistive element 602-3 or 603-4 is arranged over the first arm 4022 or the second arm 4024. According to some embodiments, referring to FIG. 4A and FIGS. 6C and 6D, the resistive element 602-3 or 602-4 is arranged over the first optical coupler 4026 or the second optical coupler 4028. The resistive element 602-3 or 602-4 may be offset from a central line between the first arm 4022 and the second arm 4024 and is made closer to the first arm 4022 or the second arm 4024. The resistive element 602-3 or 602-4 may partially overlap first optical coupler 4026 or the second optical coupler 4028 from a top-view perspective. The resistive element 602-3 or 602-4 is close to but separated from the first arm 4022 or the second arm 4024 by the second insulating layer 430. The resistive element 602-3 or 602-4 may have a material similar to the resistive element 602-1.

Referring to FIG. 6E and FIG. 6F, a resistive element 602-5 or 603-6 is arranged below the first arm 4022 or the second arm 4024. According to some embodiments, referring to FIG. 4A and FIGS. 6E and 6F, the resistive element 602-5 or 602-6 is arranged below the first optical coupler 4026 or the second optical coupler 4028. The resistive element 602-5 or 602-6 may be offset from a central line between the first arm 4022 and the second arm 4024 and is made closer to the first arm 4022 or the second arm 4024. The resistive element 602-5 or 602-5 may partially overlap first optical coupler 4026 or the second optical coupler 4028 from a top-view perspective. The resistive element 602-5 or 602-6 is close to but separated from the first arm 4022 or the second arm 4024 by the first insulating layer 410. The resistive element 602-5 or 602-6 may have a material similar to the resistive element 602-1.

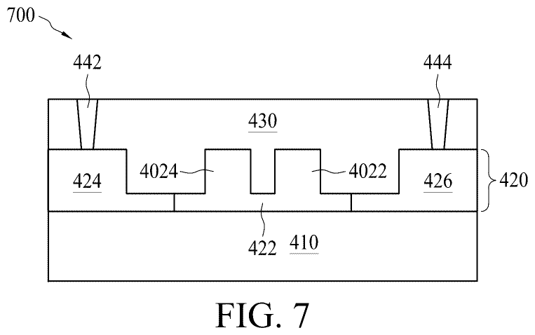

FIG. 7 shows a block diagram of a cross-sectional view of an MZI 700, in accordance with some embodiments of the present disclosure. The MZI 700 is similar to the MZI 400 or 401 shown in FIG. 4A or 4C, respectively. The cross-sectional view is taken from a section line traversing one of the first optical coupler 4026, the second optical coupler 4028, the first wavelength modulator 4025 and the second wavelength modulator 4027. According to some embodiments, the MZI 700 includes a first insulating layer 410, a substrate 420 and a second insulating layer 430. According to some embodiments, the first insulating layer 410 and the second insulating layer 430 include a dielectric material, such as silicon oxide or the like, and serve as a cladding layer of the optical waveguide of the MZI 600, e.g., the first arm 4022 and the second arm 4024.

The MZI 700 further includes one or more optical waveguides, e.g., a first arm 4022 and a second arm 4024, arranged in a central portion 422 of the substrate 420. The MZI 700 may include a doped modulator including first doped region 424 and a second doped region 426 formed on opposite sides of the central portion 422 in the substrate 420. The doped modulator may be used to implement the first power modulator 4021, the second power modulator 4023, the first wavelength modulator 4025 and the second wavelength modulator 4027.

According to some embodiments, the first doped region 424 and the second doped region 426 have a P-type dopant, such as boron and aluminum. According to some embodiments, the first doped region 424 and the second doped region have an N-type dopant (such as arsenic and phosphorus) and a P-type dopant, respectively, or vice versa. According to some embodiments, the doped modulator further includes at least part of the central portion 422, where the central portion 422 may be undoped or include a P-type dopant with a doping concentration less than that of the doped region 424 or 426.

Moreover, the MZI 700 further includes conductive vias 442 and 444 electrically coupled to the doped regions 424 and 426, respectively, and configured to provide a biasing voltage to the doped regions 424 and 426, where the carrier concentration in the doped regions 424 and 426 and the central portion 422 may change due to an electrical current flowing between the doped regions 424 and 426, and thus the refractive index of the substrate 420 may change accordingly. When the doped modulator are subject to a biasing voltage, the optical coupling performance between the first arm 4022 and the second arm 4024 is changed due to the variation of the refractive index of the central portion 422, and therefore the power distribution in the first arm 4022 and the second arm 4024, or the selected wavelength in the first arm 4022 or the second arm 4024, will change accordingly, in which whether the power distribution changes or the selected wavelength changes depends on the arranged location of the doped regions 424 and 426. According to some embodiments, the doped modulator also converts at least part of the electrical energy of the biasing voltage to thermal energy for heating the first arm 4022 and the second arm 4024. As such, the doped modulator may function like the heater modulator.

Although FIG. 7 only shows the cross-sectional view around the first power modulator 4021 or the second power modulator 4023 where both of the first arm 4022 and the second arm 4024 are present, the disclosure is not limited thereto. The arrangement of the doped modulator shown in FIG. 7 also applies to the first wavelength modulator 4025 and the second wavelength modulator 4027 where only one of the first arm 4022 and the second arm 4024 is present around the doped modulator.

According to some embodiments, the biasing voltages of the doped modulator used on the first power modulator 4021 or the second power modulator 4023 may be different for different desired power ratios of the first optical coupler 4026 or the second optical coupler 4028. Likewise, the biasing voltages of the doped modulator used on the first wavelength modulator 4025 or the second wavelength modulator 4027 may be different for different desired wavelengths to be demultiplexed.

Referring to FIG. 2, after all of the optical signals S36 in each of the groups (e.g., group G1 or G2) have been individually extracted and generated by the WDDeM 306 in the respective time periods (e.g., time period T₁ or T₂), each group of the optical signals S36 are sent to the plurality of phase shifters 308. The number of the phase shifters 308 may be equal to the number K of the optical signals S36 generated by the MZI 401 or 500. According to some embodiments, the phase shifters 308 have a structure similar to the doped modulator described with reference to FIG. 7. Different from the MZI 700 in which the doped modulator is arranged around the locations of the first power modulator 4021 (or first optical coupler 4026), the second optical coupler 4028 (or the second power modulator 4023), the first wavelength modulator 4025 and the second wavelength modulator 4027, the phase shifter 308 is arranged downstream of the second optical coupler 4028. According to some embodiments, each of the phase shifters 308 includes the same doped modulators with similar doping configurations of the first doped region 424 and the second doped region 426. Further, each of the phase shifters 308 receives substantially equal biasing voltages to generate substantially equal phase shift values for a certain group of the optical signals S36. According to some embodiments, the phase shift value generated on each group of the optical signals S36 that is under demultiplexing corresponds to a time delay between the time instant when this group is selected to be multiplexed and the time instant when the last group is selected to be multiplexed. According to some embodiments, the phase shift value corresponds to a time delay between group-m (i.e., the current group) and the final group, e.g., T₁×(m−1). According to some embodiments, no additional phase shift will be added to the optical signals S36 in the last group when they pass through the phase shifters 308. As a result, a plurality of phase-shifted optical signals S38 are generated.

According to some embodiments, after all of the phase-shifted optical signals S38 in each of the groups (e.g., group G1 or G2) have been generated by the plurality of phase shifters 308 in the respective time periods (e.g., time period T₁ or T₂), each group of the phase-shifted optical signals S38 are sent to the plurality of photodetectors 310. The number of the photodetectors 310 may be equal to the number K of the optical signals S36 generated by the MZI 401 or 500. According to some embodiments, each of the photodetectors 310 includes a photodiode or other similar opto-electrical converters. The phase-shifted optical signals S38 may be converted to electrical signals S40 at the outputs of the photodetectors 310 in the form of electrical currents that are transmitted to the electrical device 202.

After the electrical signals S40 are transmitted to the electrical device 202, these electrical current signals S40 are fed into the plurality of ADCs 270. The ADCs 270 are configured to convert analog electrical signals into their digital counterparts. According to some embodiments, the electrical device 202 further includes a plurality of transimpedance amplifiers (TIAs) (not separately shown) at the inputs of the ADCs 270 and configured to convert the current signals at the outputs of the photodetectors 310 into voltage signals. The voltage signals may be fed to the ADCs 270 to generate K receiver values S42 representing the K optical signals S36 generated by the WDDeM 306 in a specific processing time period. The K receiver values S42 are subsequently transmitted to the comparator 248, which is configured to perform data comparison to select a maximal (or minimal) value among the input values S42 as the comparison result and provide this comparison result to the processing unit 242.

Referring to FIG. 3A, the reference optical signal S33 is transmitted to a corresponding phase shifter 308 to form a phase-shifted reference optical signal S37. According to some embodiments, the phase shifter 308 is omitted for the reference optical signal S33 or the phase shift value for the reference optical signal S33 is zero degrees. Subsequently, the phase-shifted reference optical signal S37 is transmitted to a corresponding photodetector 310 to form a reference electrical signal S39. The reference electrical signal S39 is transmitted to a corresponding ADC 270 to form a digital reference value S41.

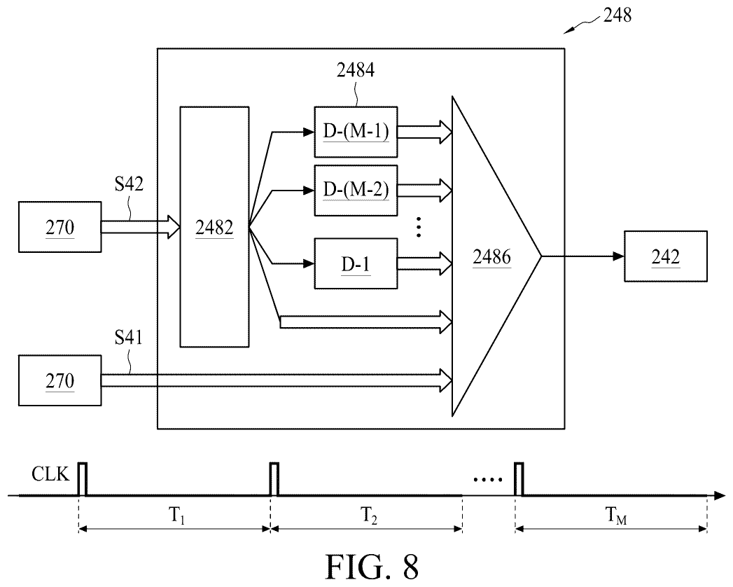

FIG. 8 illustrates a block diagram of the comparator 248 of the semiconductor device 20 shown in FIG. 2, in accordance with some embodiments of the present disclosure. Referring to FIG. 2 and FIG. 8, each group of the receiver values S42 is sent to the comparator 248 in the respective time periods T₁, T₂, . . . , T_{M}, in a serial manner. According to some embodiments, the comparator 248 includes a demultiplexer (DeMUX) 2482, a plurality of delay units 2484 and a comparison module 2486.

According to some embodiments, the M groups of the receiver values S42 are sent to the DeMUX 2482 in the respective m-th time period Tm, where m=1, 2, . . . , M. Therefore, these M groups of the receiver values S42 do not arrive at the comparison module 2486 at the same time. Since the comparison module 2486 can perform data comparison with a concurrent data comparison mode only, the delay units 2484 are introduced in front of the comparison module 2486 to compensate for the arrival time differences among the different groups of receiver values S42. For example, the first group of the K receiver values S42 arrive at the comparator 248 at the end of the time period T₁, while the last group of the K receiver values S42 arrive at the comparator at the end of the time period T_{M}. Therefore, the first group of K receiver values S42 are delayed by the time periods spanning the time periods of T₂, T₃, . . . , T_{M}. Assume each of the time periods are equal, and thus the first delay unit 2484 for the first group of K receiver values includes a delay time of (M−1)×T₁. Similarly, the second delay unit 2484 includes a delay time of (M−2)×T₁.

According to the abovementioned synchronization steps of the N receiver values, all of the M groups of the N receiver values S42 can be appropriately delayed and caused to arrive at the comparison module 2486 at the same time, and the reference value S41 is also sent to the comparison module 2486 at the same time as the receiver values S42. Although not separately shown, a delay unit may be added to the reference value S41 for synchronizing the reference value S41 with the receiver values S42. The comparison module 2486 is configured to perform data comparison and output the comparison result to the processing unit 242.

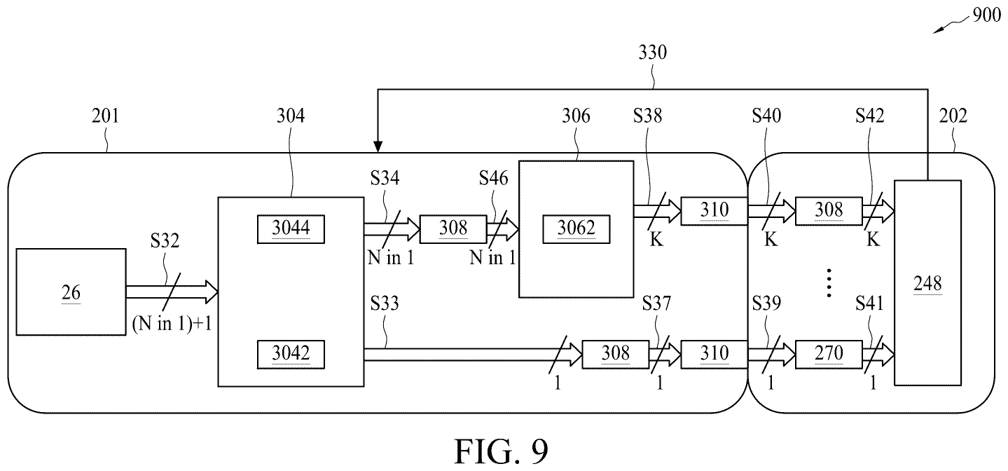

FIG. 9 illustrates a block diagram of a multichannel receiver 900, in accordance with some embodiments of the present disclosure. The multichannel receiver 900 is similar to the multichannel receiver 300 shown in FIG. 3A, and these similar features are not repeated for brevity. The main difference between the multichannel receiver 900 and the multichannel receiver 300 is that the data-only combined optical signal S34 is transmitted to the phase shifter 308 before it is transmitted to the WDDeM 306. That is, the order of the WDDeM 306 and the phase shifter 308 is interchanged. Since the processing order of the wavelength division demultiplexing of optical signals S36 and the phase shifting of the optical signals S36 can be interchanged without affecting the properties of the optical signals S36 before they are sent to the photodetectors 310, it may be advantageous to move the phase shifter 308 to the front of the WDDeM 306. The main advantage of the multichannel receiver 900 over the multichannel receiver 300 may be that the number of the phase shifter 308 can be reduced from K to one since the input signal to the phase shifter 308 in the multichannel receiver 900 is the data-only combined optical signal S34 instead of the separated and demultiplexed optical signals S36.

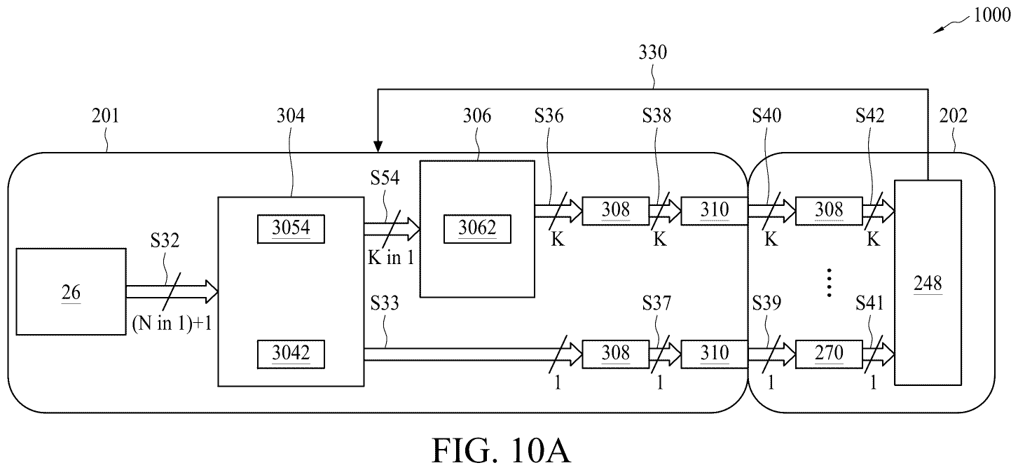

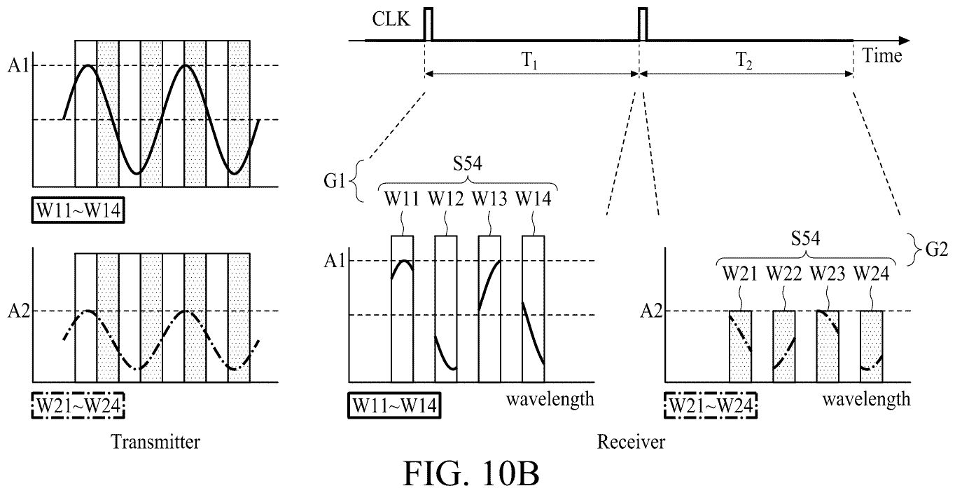

FIG. 10A illustrates a block diagram of a multichannel receiver 1000, in accordance with some embodiments of the present disclosure. The multichannel receiver 1000 is similar to the multichannel receiver 300 shown in FIG. 3A, and these similar features are not repeated for brevity. The main difference between the multichannel receiver 1000 and the multichannel receiver 300 is that the power adjustment module 3044 is replaced with a power adjustment module 3054. The main feature of the power adjustment module 3054 is that it can be used to generated different groups of data-only combined optical signals S54 in terms of the nominal maximal power in each group.

FIG. 10B shows signal waveforms and spectral responses of the data-only combined optical signal S54, in accordance with some embodiments of the present disclosure. In a left subfigure of FIG. 10B, the optical transmitter 22 is configured to transmit the optical signals into different groups with respective group-wise nominal maximal powers. For example, the optical signals S36 in the first group G1, i.e., those modulated at the wavelengths W11, W12, W13 and W14, are modulated and multiplexed with a predetermined reference maximal amplitude A1, while the optical signals S36 in the second group G2, i.e., those modulated at the wavelengths W21, W22, W23 and W24, are modulated and multiplexed with a predetermined reference maximal amplitude A2. The reference maximal amplitude A2 may be different from, e.g., less than, the reference maximal amplitude A1. The abovementioned modulation scheme can be referred to as pulse-amplitude modulation (PAM), in which the number of transmitted optical signals can be increased as compared to the mono-value for the maximal power described with reference to FIGS. 3A and 3B, since the amplitude domain of the optical signals S36 has also be leveraged to transmit different levels of signals representing different contents of data.

Referring to FIG. 10A and a right subfigure of FIG. 10B, the optical receiver 24 is configured to perform time-domain and wavelength-domain demultiplexing by help of the power adjustment module 3054 and the WDDeM 306. According to some embodiments, the power adjustment module 3054 includes an MZI similar to the MZI 401 with a single stage ST-1. Further, when applied to the power adjustment module 3054, during the first time period T₁, the length L1 of the MZI 401, the first wavelength modulator 4025 and the second wavelength modulator 4027 are configured to filter the optical signals S54 with wavelengths in the first group G1 only, i.e., the wavelengths W11, W12, W13 and W14. The power adjustment of the optical signals S54 in the first group G1 is also conducted based on the reference maximal amplitude A1. As a result, during the first time period T₁, the MZI 401 is configured to generate a data-only combined optical signal S54 including the K (e.g., four) optical signals S36 in the first group G1. Subsequently, the WDDeM 306 or the MZI 3062 performs wavelength-division demultiplexing in the first time period T₁ based on the data-only combined optical signal S54 for individually generating the K optical signals S36 in the first group G1 at the output ports of the WDDeM 306 or the MZI 3062.

Likewise, during the second time period T₂, the length L1 of the MZI 401, the first wavelength modulator 4025 and the second wavelength modulator 4027 are configured to filter the optical signals with wavelengths in the first group G2 only, i.e., of the wavelengths W21, W22, W23 and W24. The power adjustment of the optical signals in the first group G2 is also conducted based on the reference maximal amplitude A2. As a result, during the first time period T₂, the MZI 401 is configured to generate a data-only combined optical signal S54 including the K (e.g., four) optical signals S36 in the second group G2. Subsequently, the WDDeM 306 or the MZI 3062 performs wavelength-division demultiplexing in the second time period T₂ based on the data-only combined optical signal S54 for individually generating the K optical signals S36 in the second group G2 at the output ports of the WDDeM 306 or the MZI 3062.

The depicted example illustrated in FIGS. 10A and 10B shows partitioning of the combined optical signal S32 into two data-only combined optical signals S43 in different time periods. However, the present disclosure is not limited thereto, and the number of partitions more than two for the combined optical signal S32 is also within the contemplated scope of the present disclosure.

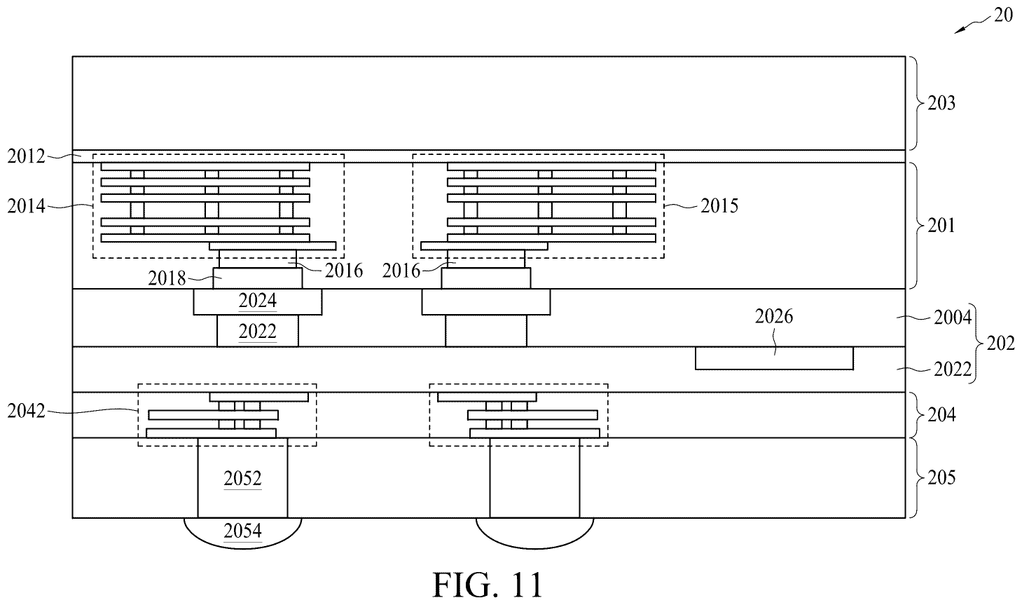

FIG. 11 shows a block diagram of a cross-sectional view of the semiconductor device 20 shown in FIG. 2, in accordance with some embodiments of the present disclosure. Referring to FIG. 2 and FIG. 11, the semiconductor device 20 shown in FIG. 11 includes the optical device 201, the electrical device 202, a protection layer 203, a backside interconnect structure 204, and a connector layer 205.

According to some embodiments, the optical device 201 includes an optical circuit layer 2012 and an interconnect structure 2014. The optical circuit layer 2012 includes one or more optical circuits, including the input modulators 2102 and the weight modulators 2202 in the optical transmitter 22, the optical channel 26, and the power splitter 304, the WDDeM 306, the phase shifters 308 and the photodetectors 310 in the optical receiver 24. According to some embodiments, the optical device 201 further includes optical input/output circuits, such as a grating coupler configured to receive or transmit optical signals from or to an upper surface of the optical device 201 facing the protection layer 203.

According to some embodiments, the interconnect structure 2014 includes one or more multilayer structures 2015 of metallization layers, in which each metallization layer includes a plurality of conductive lines. The conductive lines in each of the metallization layers are electrically interconnected to form an interconnection network for routing the electrical data lines and power lines between the optical device 201 and the electrical device 202. According to some embodiments, the interconnect structure 2014 further includes conductive vias 2016 and conductive pads 2018 configured to electrically couple the data lines and power lines of the multilayer structures 2015 to the electrical device 202.

According to some embodiments, the electrical device 202 includes an electrical circuit layer 2002 and a front-side interconnect structure 2004. The electrical circuit layer 2002 may include a plurality of semiconductor field-effect transistors 2026 forming semiconductor circuits, including the controller 240 (including the processing unit 242, the memory device 244, the signal buffer 246 and the comparator 248), the DACs 250 and 260, and ADCs 270.

According to some embodiments, the front-side interconnect structure 2004 is formed on the front-side of the electrical circuit layer 2002 and includes one or more multilayer structures (not separately shown, but are similar to the multilayer structure 2015), which form an interconnection network for routing the electrical data lines and power lines between the optical device 201 and the electrical circuit layer 2002. According to some embodiments, the front-side interconnect structure 2004 further includes conductive vias 2022 and conductive pads 2024 configured to electrically couple the data lines and power lines of the optical device 201 to the electrical circuit layer 2002.

According to some embodiments, the protection layer 203 is arranged over the optical device 201. The protection layer 203 may be formed of a dielectric material, such as silicon oxide, silicon nitride, or other suitable materials. The protection layer may be transparent to light such that a light beam can be transmitted to the optical inputs, or from the optical outputs, of the optical circuit layer 2012.

According to some embodiments, the backside interconnect structure 204 is formed on the backside of the electrical circuit layer 2002 and includes one or more multilayer structures 2042, which form an interconnection network for routing the electrical data lines and power lines of the electrical device 202 or between the electric device 202 and the connector layer 205. The power lines of the backside interconnect structure 204 is also referred to as a backside power delivery network (BSPDN) configured to provide power and ground nodes to the electrical circuits in the electrical circuit layer 2002. As the width and spacing of the conductive lines and conductive vias for forming power lines continue to be made smaller due to the footprint reduction of the transistors, the electrical resistance of these power lines formed in the front-side interconnect structure 2004 is getting larger, thereby causing greater voltage drop and power loss during power transmission. The BSPDN, however, can be formed with greater line and via widths and relieves the voltage drop of the power lines, thereby increasing the power delivery performance without sacrificing the footprint of the electrical device 202.

According to some embodiments, the connector layer 205 includes one or more conductive vias 2052 and one or more connectors 2054. The conductive vias 2052 electrically couple the electrical device 202 to the connectors 2054, and the connectors 2054 electrically couple the semiconductor device 20 to other semiconductor devices.

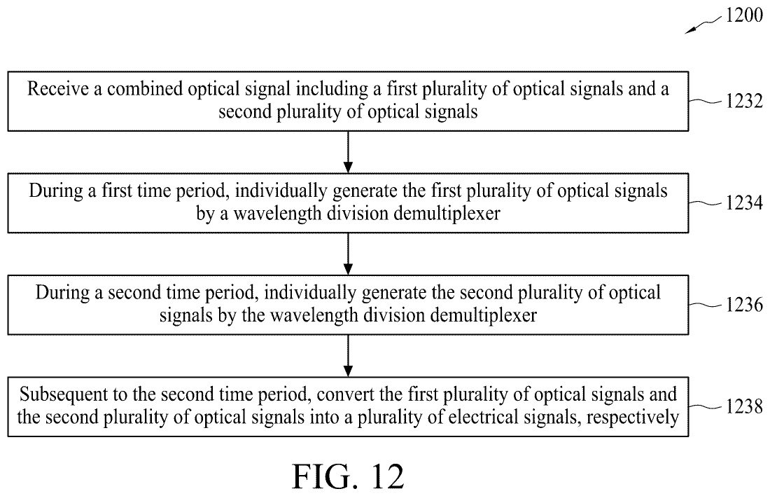

FIG. 12 shows a schematic flow chart of a method 1200 of operating a semiconductor optical computing device, in accordance with some embodiments of the present disclosure. It shall be understood that additional steps can be provided before, during, and after the steps in method 800, and some of the steps described below can be replaced with other embodiments or eliminated. The order of the steps shown in FIG. 12 may be interchangeable. Some of the steps may be performed concurrently or independently.

At step 1232, a combined optical signal including a first plurality of optical signals and a second plurality of optical signals is received.

At step 1234, during a first time period, the first plurality of optical signals are individually generated by a wavelength division demultiplexer.

At step 1236, during a second time period, the second plurality of optical signals are individually generated by the wavelength division demultiplexer.

At step 1238, subsequent to the second time period, the first plurality of optical signals and the second plurality of optical signals are converted into a plurality of electrical signals, respectively.

In accordance with one embodiment of the present disclosure, a method includes: receiving a combined optical signal including a first plurality of optical signals and a second plurality of optical signals; during a first time period, individually generating the first plurality of optical signals by a wavelength division demultiplexer; during a second time period, individually generating the second plurality of optical signals by the wavelength division demultiplexer; and subsequent to the second time period, converting the first plurality of optical signals and the second plurality of optical signals into a plurality of electrical signals respectively.

In accordance with one embodiment of the present disclosure, a method includes: receiving a combined optical signal including a first plurality of optical signals and a second plurality of optical signals; during a first time period, individually generating the first plurality of optical signals by a wavelength division demultiplexer; causing a first phase shift on each of the first plurality of optical signals to generate a third plurality of optical signals; during a second time period, generating the second plurality of optical signals by the wavelength division demultiplexer; causing a second phase shift on each of the second plurality of optical signals to generate a fourth plurality of optical signals; and subsequent to the second period, converting the third plurality of optical signals and the fourth plurality of optical signals into a first plurality of electrical signals and a second plurality of electrical signals, respectively.

In accordance with one embodiment of the present disclosure, a semiconductor device includes: a power splitter configured to receive a combined optical signal including a first plurality of optical signals and a second plurality of optical signals; a wavelength division demultiplexer configured to: during a first time period, individually generating the first plurality of optical signals from the combined optical signal; and during a second time period, individually generating the second plurality of optical signals from the combined optical signal. The semiconductor device further includes a plurality of photodetectors configured to convert the first plurality of optical signals and second plurality of optical signals into a first plurality of electrical signals and a second plurality of electrical signals, respectively.

The foregoing outlines structure of several embodiments so that those skilled in the art may better understand the aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
receiving a combined optical signal comprising a first plurality of optical signals and a second plurality of optical signals;
during a first time period, individually generating the first plurality of optical signals by a wavelength division demultiplexer;
during a second time period, individually generating the second plurality of optical signals by the wavelength division demultiplexer; and
subsequent to the second time period, converting the first plurality of optical signals and the second plurality of optical signals into a plurality of electrical signals respectively.

2. The method of claim 1, further comprising performing a phase shift on each of the first plurality of optical signals.

3. The method of claim 2, wherein the phase shift corresponds to a time delay equal to the first time period.

4. The method of claim 1, wherein the combined optical signal further comprises a reference optical signal, further comprising extracting the reference optical signal from the combined optical signal.

5. The method of claim 4, wherein the extracting of the reference optical signal from the combined optical signal comprises generating the reference optical signal from the combined optical signal through a longpass filter.

6. The method of claim 1, further comprising performing power adjustment on the combined optical signal prior to the first time period.

7. The method of claim 1, further comprising generating a first combined optical signal comprising the first plurality of optical signals based on a first maximal amplitude prior to individually generating the first plurality of optical signals.

8. The method of claim 7, further comprising generating a second combined optical signal comprising the second plurality of optical signals based on a second maximal amplitude different from the first maximal amplitude prior to individually generating the second plurality of optical signals.

9. The method of claim 1, wherein the generating of the first plurality of optical signals comprises causing heating the wavelength division demultiplexer to a first temperature.

10. The method of claim 9, wherein the generating of the second plurality of optical signals comprises heating the wavelength division demultiplexer to a second temperature different from the first temperature.

11. The method of claim 1, wherein the wavelength division demultiplexer comprises a wavelength modulator configured to receive a first biasing voltage for generating of the first plurality of optical signals.

12. The method of claim 11, wherein the generating of the second plurality of optical signals comprises causing the wavelength modulator to receive a second biasing voltage, different from the first biasing voltage, for generating the second plurality of optical signals.

13. A method, comprising:
receiving a combined optical signal comprising a first plurality of optical signals and a second plurality of optical signals;
during a first time period, individually generating the first plurality of optical signals by a wavelength division demultiplexer;
causing a first phase shift on each of the first plurality of optical signals to generate a third plurality of optical signals;
during a second time period, generating the second plurality of optical signals by the wavelength division demultiplexer;
causing a second phase shift on each of the second plurality of optical signals to generate a fourth plurality of optical signals; and
subsequent to the second time period, converting the third plurality of optical signals and the fourth plurality of optical signals into a first plurality of electrical signals and a second plurality of electrical signals, respectively.

14. The method of claim 13, wherein the wavelength division demultiplexer comprises a Mach-Zehnder interferometer.

15. The method of claim 13, wherein the second phase shift is zero degrees.

16. The method of claim 13, further comprising delaying the first plurality of electrical signals and performing a comparison based on the delayed first plurality of electrical signals and the second plurality of electrical signals.

17. A semiconductor device, comprising:
a power splitter configured to receive a combined optical signal comprising a first plurality of optical signals and a second plurality of optical signals;
a wavelength division demultiplexer configured to:
during a first time period, individually generating the first plurality of optical signals from the combined optical signal; and
during a second time period, individually generating the second plurality of optical signals from the combined optical signal; and
a plurality of photodetectors configured to convert the first plurality of optical signals and second plurality of optical signals into a first plurality of electrical signals and a second plurality of electrical signals, respectively.

18. The semiconductor device of claim 17, wherein the first plurality of optical signals and the second plurality of optical signals have a same number K of optical signals, further comprising a number K of phase shifters configured to perform a phase shift on outputs of the wavelength division demultiplexer.

19. The semiconductor device of claim 17, further comprising a comparator configured to generate a comparison result based on the first plurality of electrical signals and the second plurality of electrical signals.

20. The semiconductor device of claim 17, wherein the power splitter is further configured to generate a combined optical signal comprising only the first plurality of optical signals or only the plurality of second optical signals.
